(19) United States
(12) Patent Application Publication
(10) Pub. No.: US 2023/0012574 A1
(43) Pub. Date: Jan. 19, 2023

(54) MULTI-ZONE DISPLAY PRIVACY BASED ON LOCATION AND CONTENT

(71) Applicant: Hewlett-Packard Development Company, L.P., Spring, TX (US)

(72) Inventors: Syed S. Azam, Spring, TX (US); Martin Joshy, Spring, TX (US); Anthony N. Kaplanis, Spring, TX (US)

(73) Assignee: Hewlett-Packard Development Company, L.P., Spring, TX (US)

(21) Appl. No.: 17/783,324

(22) PCT Filed: Jan. 14, 2020
(86) PCT No.: PCT/US2020/013460

§ 371 Date: Jun. 8, 2022

(51) Int. Cl. G06F 21/62

(52) U.S. Cl. CPC G06F 21/6245

(57) ABSTRACT

Examples of multi-zone display privacy based on location and content are described. In some examples, an electronic device may include a location engine to determine a location of the electronic device. The electronic device may also include a privacy engine to determine the location to be an insecure location and to determine that displayed data includes sensitive information. In some examples, the electronic device may include a display controller to enable a privacy mode in a zone of a multiple-zone display screen in response to a determination that the location is an insecure location and the displayed data includes sensitive information.

### BACKGROUND

Electronic devices such as computing devices may display data. For example, an electronic device may cause data to be displayed on a display screen. In some examples, the display screen may be integrated with the electronic device. In other examples, the display screen may be separate from the electronic device. Electronic devices may be used in different settings. For example, an electronic device may be used in a public or private environment.

### BRIEF DESCRIPTION OF THE DRAWINGS

Various examples will be described below by referring to the following figures.

FIG. 1 is a block diagram of an example of an electronic device to implement multi-zone display privacy;

FIG. 2 is a flow diagram illustrating an example of a method for multi-zone display privacy based on location and content;

FIG. 3 is a block diagram illustrating another example of an electronic device to implement multi-zone display privacy;

FIG. 4 is an example illustrating a multi-zone display screen in privacy mode and sharing mode;

FIG. 5 is a flow diagram illustrating another method for multi-zone display privacy based on location and content; and

FIG. 6 is a flow diagram illustrating yet another method for multi-zone display privacy based on location and content.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations in accordance with the description; however, the description is not limited to the examples and/or implementations provided in the drawings.

### DETAILED DESCRIPTION

Electronic devices such computing devices (e.g., laptop computers, desktop computers, tablet devices, smartphones, gaming systems, etc.) may display data on a display screen. In some cases, the displayed data may include sensitive information that should be kept private. For example, the sensitive information may include passwords, financial information, medical information, or any other information that a user or organization wants to keep private.

Today, users and organizations are more conscious about keeping information private, especially with the increase of people working remotely and in public places. As electronic devices become smaller and more ubiquitous, it has become easier to use electronic devices in different locations. In some cases, a location may be a secure location. For example, an electronic device may be used in a secure office environment where the display of data that includes sensitive information may be safe. In other cases, an electronic device may be used in an insecure location. For example, the electronic device may be used in a public location (e.g., coffee shop, airport, hospital, bank lobby, etc.) In this case, it may be desirable to keep the displayed data private to minimize the ability for unintended viewers to observe the displayed data. Keeping information private on the display screen for an intended user is one example of maintaining security.

Examples are described herein that relate to enabling or disabling a privacy mode in one or multiple zones of a multiple-zone display screen. As used herein, a “zone” is a region of a display screen that is controlled by a display controller. The display parameters of one zone may be controlled independent of other zones. In some examples, a display controller may change the parameters of a given zone. In some examples, the electronic device may include multiple display controllers with one display controller for each of the multiple zones.

As used herein, a “display controller” may include electronic circuits that generate a video signal for a zone of a display screen. A display controller may also be referred to as a video display controller, display engine or display interface. In some examples, the display controller may control the timing of video signals and access to the video memory (e.g., RAM). The display controller may copy the content from the video memory of an image frame. The display controller may output to the display screen across a display interface standards. For example, a pixel on the display screen can be represented in memory. The display controller may read the memory for an image frame and may generate interface signals to encode the pixel color for the display screen.

In some examples, a display controller may also control other display parameters in addition to pixel color. For example, a display controller may adjust the amount of light emitted by a zone of the display screen. In another example, the display controller may adjust a viewing angle of the zone. In yet another example, the display controller may adjust the opacity of a polymer dispersed liquid crystal (PDLC) film in a zone of the display screen.

In some examples, a privacy mode may be enabled or disabled automatically based on various triggers. As described herein, an electronic device may enable or disable a privacy mode in one or multiple zones based on the location of the electronic device and the content of a displayed data. In particular, the zones of the display screen of the electronic device can be dynamically switched between a privacy mode and a sharing mode based on the detected location of the electronic device and the content of the displayed data. Additionally, privacy mode may be enabled for individual zones based on which zone(s) is currently displaying the data.

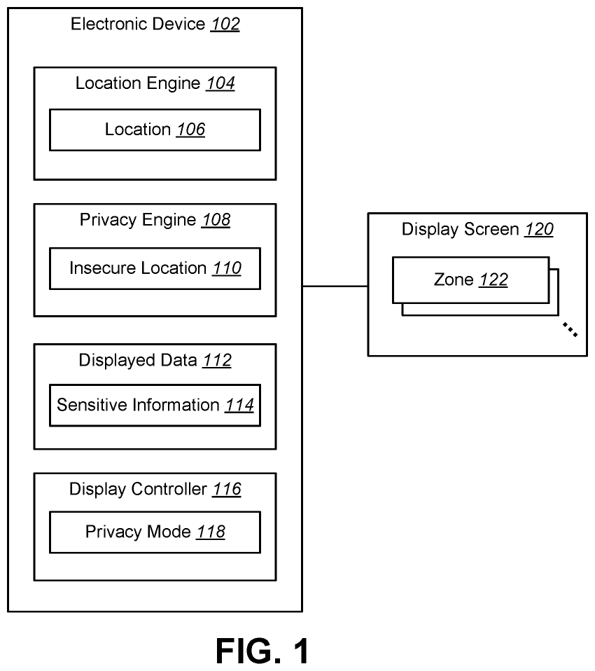

FIG. 1 is a block diagram of an example of an electronic device 102 to implement multi-zone display privacy. In some examples, the electronic device 102 may be a computing device, such as a laptop computer, a desktop computer, a smartphone, a tablet computer, a gaming console, etc.

The electronic device 102 may include and/or may be coupled to a processor and/or memory (not shown). The processor may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory. The processor may fetch, decode, and/or execute instructions stored in the memory. In some examples, the processor may include an electronic circuit or circuits that include electronic components for performing a function or functions of the instructions (e.g., location engine 104, privacy engine 108). In some examples, the processor may perform one, some, or all of the functions, operations, elements, methods, etc., described in connection with one, some, or all of FIGS. 1-6.

The memory may be any electronic, magnetic, optical, or other physical storage device that contains or stores electronic information (e.g., instructions and/or data). The memory may be, for example, Random Access Memory (RAM), Electrically Erasable Programmable Read-Only Memory (EEPROM), a storage device, an optical disc, and the like. In some examples, the memory may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory may be a non-transitory tangible machine-readable storage medium, where the term “non-transitory” does not encompass transitory propagating signals. In some examples, the memory may include multiple devices (e.g., a RAM card and a solid-state drive (SSD)).

In some examples, the electronic device 102 may include an input/output interface through which the processor may communicate with an external device or devices (e.g., external source of displayed data 112), for instance, to receive and store information (e.g., the displayed data 112). The input/output interface may include hardware and/or machine-readable instructions to enable the processor to communicate with the external device or devices. The input/output interface may enable a wired or wireless connection to the external device or devices (e.g., external source of displayed data 112, etc.). The input/output interface may further include a network interface card and/or may also include hardware and/or machine-readable instructions to enable the processor to communicate with various input and/or output devices, such as a keyboard, a mouse, a touchscreen, a microphone, a controller, another apparatus, electronic device, computing device, etc., through which a user may input instructions into the electronic device 102.

The electronic device 102 may communicate with a display screen 120. In some examples, the electronic device 102 may include the display screen 120. For example, a laptop computer, smartphone or tablet computer may have an integrated display screen 120. In other examples, the display screen 120 may be separate from the electronic device 102. In this case, the electronic device 102 may control the display screen 120 by sending signals to the display screen 120.

The display screen 120 may include multiple zones 122. A zone 122 is a discrete region of the display screen 120 that is controlled by a certain display controller 116. Parameters of one zone 122 may be controlled independent of other zones 122. For example, a zone 122 may include a number of pixels whose parameters are controlled by the display controller 116. In an example, the display controller 116 may adjust the amount of light emitted by pixels in a zone 122.

In another example, a zone 122 may include non-pixel elements that are controlled by a display controller 116. For instance, a zone 122 may include a polymer dispersed liquid crystal (PDLC) film that changes the opacity of the zone 122 based on an electrical charge provided by the display controller 116. In another example, a display controller 116 may adjust the amount of light emitted by a backlight in the zone 122. In yet another example, the display controller 116 may adjust the viewing angle of a zone 122.

In yet another example, multiple zones 122 may be combined to create a bigger zone 122. For example, if the display screen 120 includes four zones 122, two, three or all four of the zones 122 may be combined to form a larger privacy zone 122. The shape, size and/or other characteristics of the combined zones 122 may depend on environmental parameters (e.g., lighting conditions, location 106, geofencing defining a safe location, etc.).

The display screen 120 may include two zones 122 or more than two zones 122. For example, the display screen 120 may be divided into a left zone and a right zone. In another example, the display screen 120 may be divided into four zones 122 arranged in quadrants. Other numbers and/or arrangements of zones 122 may be implemented in accordance with the examples described herein.

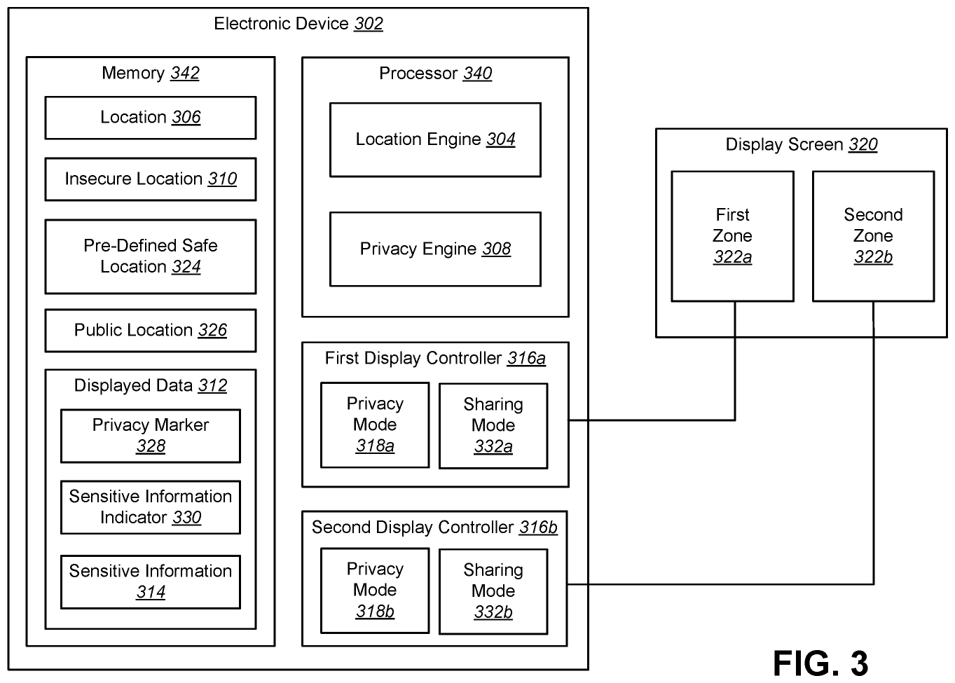

In some examples, the electronic device 102 may include a separate display controller 116 for each of the zones 122 in the display screen 120. For example, if the display screen 120 has two zones 122, the electronic device 102 may include two display controllers 116. If the display screen 120 has four zones 122, the electronic device 102 may include four display controllers 116, and so forth. It should be noted that for ease of description, one display controller 116 is shown in FIG. 1. It is assumed that the display controller 116 of FIG. 1 may control a given zone 122 of the display screen 120. In other implementations, the electronic device 102 may include multiple display controllers 116, where each display controller 116 controls one of the multiple zones 122, as depicted in FIG. 3.

In other examples, a single display controller 116 may control multiple zones 122. In this case, the parameters of the different zones 122 may be controlled independent of each other by the single display controller 116.

The electronic device 102 may include additional components (not shown) and/or some of the components described herein may be removed and/or modified without departing from the scope of this disclosure.

The electronic device 102 may include a location engine 104 to determine the location 106 of the electronic device 102. In some examples, the location engine 104 may be a combination of circuits and executable instructions. In some examples, the location engine 104 may be implemented by a processor executing instructions stored in memory. In some examples, the location engine 104 may include a location tracking sensor(s). For instance, the location engine 104 may include a Global Positioning System (GPS) receiver. In other examples, the location engine 104 may include a location-based service that provides the location of the electronic device 102.

In yet another example, the location engine 104 may determine the location 106 of the electronic device 102 based on an IP address of the electronic device 102. For example, the IP address may be mapped to a known geographic area. The location engine 104 may correlate the location 106 of the electronic device 102 based on the mapped IP address.

In some examples, the location engine 104 may determine the location 106 of the electronic device 102 based on an environmental factor. For example, the location engine 104 may detect signals from a wireless network or other wireless device (e.g., a Bluetooth attached accessory) that is kept at an office or other location. The detected signals may inform the location engine 104 of the location 106 of the electronic device 102. In yet another example, a light sensor (e.g., a camera) of the electronic device 102 may detect lighting conditions to determine the location of the device 102. For instance, the location engine 104 may be trained to detect landmarks or lighting conditions within an environment to determine the location 106 of the electronic device 102. Other sensors (e.g., microphone, temperature sensor, etc.) may be used to determine environmental factors that identify the location 106 of the electronic device 102.

The electronic device 102 may include a privacy engine 108 to determine whether to enable a privacy mode 118 for a given zone 122 of the display screen 120. In some examples, the privacy engine 108 may be a combination of circuits and executable instructions. In some examples, the privacy engine 108 may be implemented by a processor executing instructions stored in memory.

The privacy engine 108 may determine the location 106 of the electronic device 102 to be an insecure location 110. For example, the electronic device 102 may determine that the electronic device 102 is in a public location. In some examples, the GPS coordinates of the current location 106 of the electronic device 102 may be mapped to a public location. In this case, the privacy engine 108 may determine that the location 106 is an insecure location 110.

In some other examples, the electronic device 102 may be configured with a pre-defined safe location. For example, a user or organization may designate a location as a safe location for purposes of privacy. In an implementation, a user may define boundaries for a region that is designated a safe location. For instance, a user may mark boundaries on a map for a safe region. The area within these boundaries may be a pre-defined safe location. In another implementation, a user may place markers on a map and an area within a certain radius of the marker may be considered a safe location. Any area outside the pre-defined safe location may be considered an insecure location 110.

The privacy engine 108 may determine that displayed data 112 includes sensitive information 114. In some examples, the displayed data 112 may be a visual representation of information. In some examples, the displayed data 112 may be a file (e.g., text document, image, website, etc.) or a portion of the file that is displayed on the display screen 120. In other examples, the displayed data 112 may be a data stream (e.g., live-streamed video, sensor reading, etc.) or other information that is not in a file format.

In some examples, the privacy engine 108 may determine that displayed data 112 includes sensitive information 114 based on content of the displayed data 112 that is marked as private. For example, a user or organization may mark the displayed data 112 (e.g., file, data stream, etc.) as “private.” In an example, a user may mark a text document as “private.” In another example, all files stored in a certain data store (e.g., folder, drive, directory, etc.) may be marked as private due to their location in a private data store. In the case of a data stream, any data stream from a designated source may be marked as private. This private designation may be stored as metadata of the displayed data 112, or may be associated (e.g., mapped) with the displayed data 112. It should be noted that in this example, any data may be marked as “private.” In this case, that data may be treated as containing sensitive information 114.

In another example, the privacy engine 108 may determine that displayed data 112 includes sensitive information 114 based on an indicator that the displayed data 112 includes sensitive information 114. For example, the indicator may be information extracted from the displayed data 112 that indicates that the displayed data 112 includes sensitive information 114. For example, a password field in login portal may be an indicator that the displayed data 112 includes sensitive information 114. When the privacy engine 108 detects the presence of a password, then the privacy engine 108 may determine that the displayed data 112 includes sensitive information 114.

Other indicators for sensitive information 114 may include text included in the displayed data 112. For example, if the displayed data 112 includes certain phrases (e.g., “confidential,” “sensitive,” “private,” etc.) or relates to certain subjects (e.g., banking, medical, legal, etc.), the privacy engine 108 may determine that the displayed data 112 includes sensitive information 114.

Yet another indicator for sensitive information 114 may be the source of the displayed data 112. For example, an IP address or domain name for a website that provides the displayed data 112 may indicate that the displayed data 112 includes sensitive information 114. For example, displayed data 112 originating from a banking website may be considered to include sensitive information 114. In another example, any displayed information 114 originating from a work server may be considered to include sensitive information 114.

The display controller 116 may enable a privacy mode 118 in a zone 122 of the multiple-zone display screen 120 in response to a determination that the location 106 is an insecure location 110 and the displayed data 112 includes sensitive information 114. For example, if the privacy engine 108 determines that the location 106 is insecure and the displayed data 112 includes sensitive information 114, then the privacy engine 108 may instruct the display controller 116 to enable privacy mode 118 for a zone 122.

In some examples, enabling privacy mode 118 may include adjusting the display parameters of a zone 122 of the display screen 120 to decrease the observability of the displayed data 112. Different approaches may be implemented for the privacy mode 118.

In an example approach, enabling privacy mode 118 may include decreasing the amount of light emitted in a zone 122. In this approach, the display controller 116 may decrease the light emitted in a zone 122. This approach may be referred to as dark privacy.

In another example approach, enabling privacy mode 118 may include increasing the amount of light emitted in a zone 122. In this approach, the display controller 116 may increase (e.g., saturate) the light emitted in a zone 122. This approach may be referred to as white privacy where the light emitted in the zone 122 is saturated. This approach may make observing (e.g., reading, comprehending, recording, etc.) the displayed data 112 difficult for viewers (e.g., human, camera, etc.) that are not close to and in front of the display screen 120.

In another example approach, enabling privacy mode 118 may include adjusting a viewing angle of the zone 122. In this approach, the display controller 116 may decrease the viewing angle in a zone 122. This may be accomplished by controlling the voltage applied to control the liquid crystal movement. For example, if a higher charge is applied to the zone 122, the liquid crystals will move completely perpendicular. However, with a limited charge, the liquid crystal movement may be limited. This approach may make observing (e.g., reading, comprehending, recording, etc.) the displayed data 112 difficult for viewers (e.g., human, camera, etc.) that are not within the viewing angle of the zone 122.

In yet another example approach, enabling privacy mode 118 may include causing a PDLC film in the zone 122 to become opaque. In this approach, the display controller 116 may provide an electrical charge (e.g., voltage) to the PDLC film to cause the crystals in the PDLC film to align in a manner that increases the opacity of the PDLC film. This approach may make observing (e.g., reading, comprehending, recording, etc.) the displayed data 112 difficult for viewers (e.g., human, camera, etc.) that are not near and in front of the display screen 120.

It should be noted that the display controller 116 may enable privacy mode 118 for one zone 122 while other zones 122 are in a sharing mode. As used herein, “sharing mode” refers to a normal mode of operation of a zone 122 of the display screen 120. As used herein, “normal mode of operation” refers to a mode of operation in which privacy mode 118 is not applied in a zone 122. In some examples, “normal mode of operation” may include a default operation mode for the zone 122 where the display parameters are not modified by the settings of the privacy mode 118. In sharing mode 118, the display parameters (e.g., emitted light, viewing angle, PDLC film opacity) of a zone 122 are set to normal (e.g., default) operating conditions. For example, in sharing mode 118, the display parameters (e.g., emitted light, viewing angle, PDLC film opacity) of a zone 122 may be set to default conditions that are not modified by the privacy mode 118.

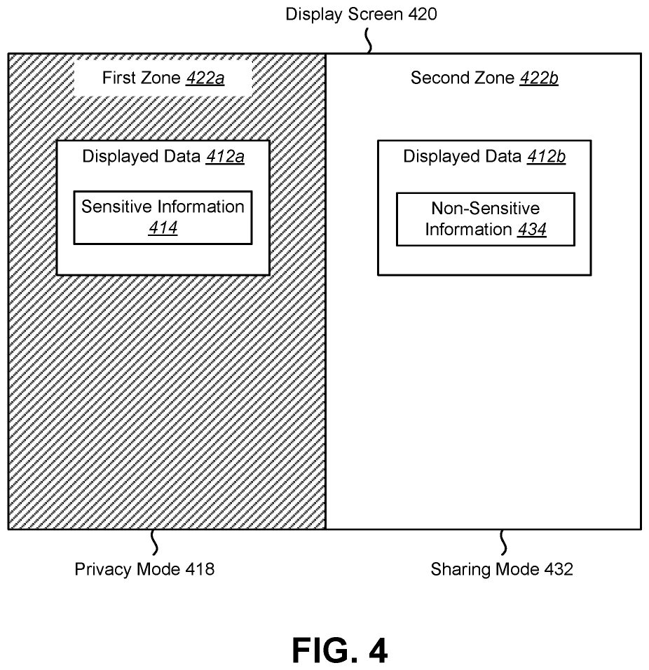

In an example, if the displayed data 112 is located in a first zone 122 and not in a second zone 122, the display controller 116 may enable privacy mode 118 in the first zone 122 while the second zone 122 may remain in a sharing mode. For instance, a document with sensitive information 114 may be displayed in a zone 122 located on the left of the display screen 120. In this case, the left zone 122 may be put in privacy mode 118 while the right zone 122 may remain in sharing mode. Therefore, privacy mode 118 may be enabled for different zones 122 of the display screen 120 based on the location of the displayed data 112 within the display screen 120. An example of this scenario is described in FIG. 4.

The described examples will enable or disable the privacy mode 118 for zones 122 of a display screen 120 based on location 106 of the electronic device 102 and content of the displayed data 112. This assists a user and/or organization in maintaining privacy of sensitive information 114 when the electronic device 102 is in an insecure location 110 (e.g., public place, outside of a pre-defined safe location(s), etc.). If the privacy engine 108 determines that the electronic device 102 is in a safe location, then the privacy mode 118 may be defaulted to off.

In some examples, activation of the privacy mode 118 may be configurable. For instance, administrators or individual users may define if the privacy mechanisms described herein are a fixed setting on the electronic device 102 or whether the privacy mechanisms may be overridden. In some examples, the electronic device 102 may include a button or other user interface to enable or disable the described privacy mechanisms.

The multi-zone display privacy mechanisms described herein give users and organizations more freedom to use the electronic device 102 in various locations 106 that may be insecure. The privacy mechanisms may allow users to switch to privacy mode 118 when circumstances warrant additional security. These privacy mechanisms assist organizations with keeping their data private when an electronic device 102 is not controlled in a secured location.

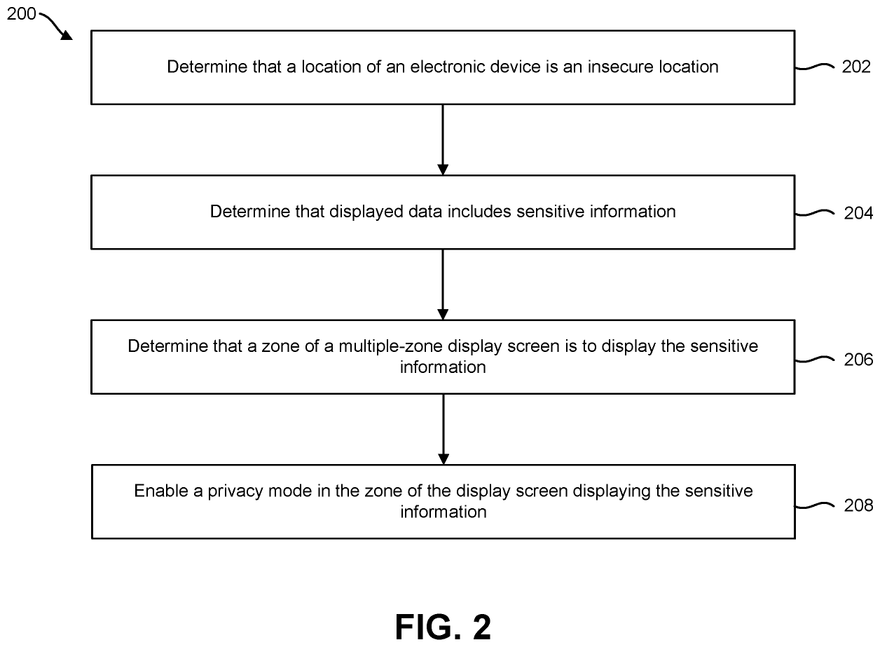

FIG. 2 is a flow diagram illustrating an example of a method 200 for multi-zone display privacy based on location and content. The method 200 may be performed by, for example, an electronic device 102 and/or a processor. In some examples, the electronic device 102 may include or may communicate with a display screen 120 with multiple zones 122.

The electronic device 102 may determine 202 that a location 106 of the electronic device 102 is an insecure location 110. For example, the electronic device 102 may determine its location 106 based on a GPS signal, an IP address, or an environmental factor. In one example, the electronic device 102 (e.g., via a processor) may determine 202 that the location 106 of the electronic device 102 is an insecure location 110 in response to a determination that the electronic device 102 is outside of a pre-defined safe location. In another example, the electronic device 102 may determine 202 that the location 106 of the electronic device 102 is an insecure location 110 in response to a determination that the electronic device 102 is in a public location.

In some examples, a processor of the electronic device 102 may determine 202 that a location 106 of the electronic device 102 is an insecure location 110. For example, the processor may determine the location 106 of the electronic device 102 is insecure by comparing GPS location data associated with the electronic device 102 to a range of location data associated with a map location designating secure locations. If the processor determines that the GPS location data indicates that the location 106 of the electronic device 102 is outside the range of location data designated as secure locations, then the processor of the electronic device 102 may determine 202 that the location 106 of the electronic device 102 is an insecure location 110.

The electronic device 102 may determine 204 that displayed data 112 includes sensitive information 114. For example, the electronic device 102 may determine that data is being displayed by the display screen 120. In one example, the electronic device 102 may determine 204 that the displayed data 112 includes sensitive information 114 based on content of the displayed data 112 that is marked as private. For instance, a user may mark data (e.g., a file or data stream) as private, sensitive or other designation indicating that the data is to be considered to include sensitive information 114. In another example, the electronic device 102 may determine 204 that the displayed data 112 includes sensitive information 114 based on an indicator that the displayed data 112 includes sensitive information 114. In some examples, a processor of the electronic device 102 may determine 204 that displayed data 112 includes sensitive information 114.

The electronic device 102 may determine 206 that a zone 122 of the multiple-zone display screen 120 is to display the sensitive information 114. For example, the electronic device 102 may determine which zone(s) 122 includes the displayed data 112. In an example, a user may place the data 112 in a certain zone 122 of the display screen 120. In some examples, a processor of the electronic device 102 may determine 206 that a zone 122 of the multiple-zone display screen 120 is to display the sensitive information 114.

The electronic device 102 may enable 208 a privacy mode 118 in the zone 122 of the display screen 120 displaying the sensitive information 114. For example, in response to determining that the location 106 is an insecure location 110 and the displayed data 112 includes sensitive information 114, a display controller 116 of the electronic device 102 may enable privacy mode 118 for the zone 122 displaying the data 112. In some examples, a processor of the electronic device 102 may enable 208 privacy mode 118 in the zone 122 of the display screen 120 displaying the sensitive information 114 in response to determining that the location 106 is an insecure location 110 and the displayed data 112 includes sensitive information 114.

In one example approach, enabling 208 the privacy mode 118 in the zone 122 may include causing a polymer dispersed liquid crystal (PDLC) film in the zone 122 to become opaque. In another example approach, enabling 208 the privacy mode 118 in the zone 122 may include increasing light emitted in the zone 122. In yet another example approach, enabling 208 the privacy mode 118 in the zone 122 may include adjusting a viewing angle of the zone 122. It should be noted that the privacy mode 118 of the zone 122 may be enabled 208 independent of other zones 122 of the display screen 120.

FIG. 3 is a block diagram illustrating another example of an electronic device 302 to implement multi-zone display privacy. The electronic device 302 may be implemented in accordance with the electronic device 102 described in FIG. 1.

In this example, the display screen 320 includes a first zone 322a and a second zone 322b. For example, the first zone 322a may be located in the left half of the display screen 320 and the second zone 322b may be located in the right half of the display screen 320. The electronic device 302 may include a first display controller 316a to control the first zone 322a. The electronic device 302 may include a second display controller 316b to control the second zone 322b.

The electronic device 302 may include a processor 340 and memory 342. The processor 340 and memory 342 may be implemented in accordance with the processor and memory described in FIG. 1.

The processor 340 may implement a location engine 304. The location engine 304 may determine the location 306 of the electronic device 102. This may be accomplished as described in FIG. 1. For example, the location engine 304 may determine the location 306 of the electronic device 302 based on a GPS signal, an IP address of the electronic device 302, and/or an environmental factor measured by the electronic device 302. In some examples, the location 306 may be stored in memory 342.

The processor 340 may also implement a privacy engine 308. The privacy engine 308 may determine whether to enable a privacy mode in the first zone 322a, the second zone 322b or both. The privacy engine 308 may determine the location 306 of the electronic device 302 to be an insecure location 310. For example, the electronic device 302 may determine that the electronic device 302 is in a public location 326. In this case, the privacy engine 308 may be configured with a map that indicates whether the current location 306 of the electronic device 302 is a public location 326. In some examples, data related to the insecure location 310, and public location 326 may be stored in memory 342.

In some other examples, the electronic device 302 may be configured with a pre-defined safe location 324. For example, an area may be designated as a safe location. If the current location 306 of the electronic device 302 is outside a pre-defined safe location 324, then the privacy engine 308 may determine that location 306 is an insecure location 310. In some examples, the pre-defined safe location 324 may be stored in memory 342.

The privacy engine 308 may determine that displayed data 312 includes sensitive information 314. In some examples, the displayed data 312 may be stored in memory 342. In some examples, the privacy engine 308 may determine that displayed data 312 includes sensitive information 314 based on a privacy marker 328. For instance, content of the displayed data 312 may be marked as private. In another example, the privacy engine 308 may determine that displayed data 312 includes sensitive information 314 based on a sensitive information indicator 330 that the displayed data 312 includes sensitive information 314. For example, the sensitive information indicator 330 may be information extracted from the displayed data 312 that indicates that the displayed data 312 includes sensitive information 314.

When the privacy engine 308 detects the privacy marker 328 and/or sensitive information indicator 330, then the privacy engine 308 may determine that the displayed data 312 includes sensitive information 314.

The privacy engine 308 may determine which zone is to display the sensitive information 314. For example, the privacy engine 308 may determine that the first zone 322a of the multiple-zone display screen 320 is to display the sensitive information 314. The privacy engine 308 may also determine that the second zone 322b does not include displayed data 312 with sensitive information 314.

The display controllers 316a,b may enable a privacy mode based on whether the location 306 is an insecure location 310 and whether the zone controlled by a given display controller 316 is to display sensitive information 314. For example, the first display controller 316a may enable privacy mode 318a in the first zone 322a of the display screen 320 in response to a determination that the location 306 is an insecure location 310 and the displayed data 312 in the first zone 322a includes sensitive information 314. If these conditions are not satisfied, then the first display controller 316a may enable a sharing mode 332a in the first zone 322a.

Continuing this example, the second display controller 316b may enable privacy mode 318b in the second zone 322b of the display screen 320 in response to a determination that the location 306 is an insecure location 310 and the displayed data 312 in the second zone 322b includes sensitive information 314. If these conditions are not satisfied, then the second display controller 316b may enable a sharing mode 332b in the second zone 322b. In other words, the second display controller 316b may enable sharing mode 332b in the second zone 322b of the display screen 320 in response to a determination that the second zone 322b does not include displayed data 312 with sensitive information 314.

It should be noted that the privacy mode 318a may be enabled in the first zone 322a and sharing mode 332b may be enabled in the second zone 322b and vice versa. For example, if the sensitive information 314 is to be displayed in the first zone 322a but not in the second zone 322b, then privacy mode 318b may be enabled in the first zone 322a and sharing mode 332b may be enabled in the second zone 322b.

In another example, privacy mode may be enabled if the displayed data 312 moves into a different zone. For example, the second display controller 316b may enable privacy mode 318b in the second zone 322b of the display screen 320 in response to a determination that the displayed data 312 with sensitive information 314 has moved from the first zone 322a to the second zone 322b. In this case, the first zone 322a may enter a sharing mode 332a if the sensitive information 314 is no longer being displayed in the first zone 322a.

FIG. 4 is an example illustrating a multi-zone display screen 420 in privacy mode 418 and sharing mode 432. In this example, the display screen 420 includes a first zone 422a and a second zone 422b. The first zone 422a is located in the left half of the display screen 420. The second zone 422b is located in the right half of the display screen 420. In this example, it is assumed that the display screen 420 is located in an insecure location.

In this example, the displayed data 412a in the first zone 422a includes sensitive information 414. In this case, privacy mode 418 is enabled in the first zone 422a (as indicated by the cross hatching in FIG. 4). In some examples, privacy mode 418 may be enabled by causing a polymer dispersed liquid crystal (PDLC) film in the first zone 422a to become opaque. In other examples, privacy mode 418 may be enabled by increasing (e.g., saturating) light emitted in the first zone 422a. In yet other examples, privacy mode 418 may be enabled by adjusting (e.g., decreasing) the viewing angle of the first zone 422a.

In this example, the displayed data 412b in the second zone 422b includes non-sensitive information 434. In this case, sharing mode 432 is enabled in the second zone 422b. In sharing mode 432, the display parameters (e.g., emitted light, viewing angle, PDLC film opacity) of the second zone 422b may be set to normal operating conditions.

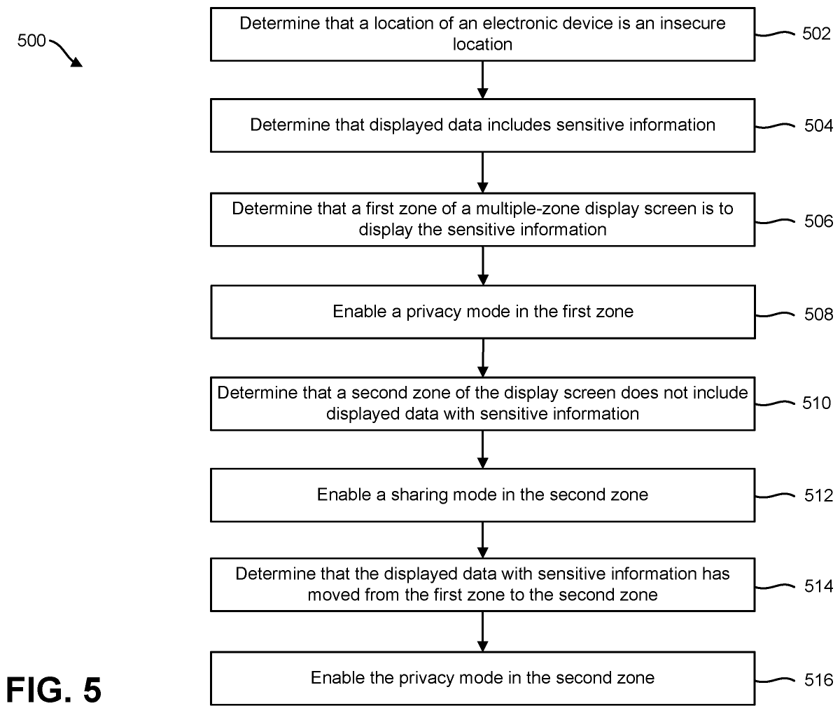

FIG. 5 is a flow diagram illustrating another method 500 for multi-zone display privacy based on location and content. The method 500 may be performed by, for example, an electronic device 302 and/or a processor 340 of the electronic device 302. In some examples, the electronic device 302 may include or may communicate with a display screen 320 with a first zone 322a and a second zone 322b.

The electronic device 302 (e.g., processor 340) may determine 502 that a location 306 of the electronic device 302 is an insecure location 310. This may be accomplished as described in connection with FIG. 1 and FIG. 3.

The electronic device 302 (e.g., processor 340) may determine 504 that displayed data includes sensitive information 314. For example, the electronic device 302 may determine 204 that the displayed data 312 includes sensitive information 314 based on a privacy marker 328 designating the content of the displayed data 312 as private. In another example, the electronic device 302 may determine 504 that the displayed data 312 includes sensitive information 314 based on a sensitive information indicator 330 that indicates the displayed data 312 includes sensitive information 314.

The electronic device 302 (e.g., processor 340) may determine 506 that a first zone 322a of the multiple-zone display screen 320 is to display the sensitive information 314. For example, the electronic device 302 may determine that the displayed data 312 with the sensitive information 314 is placed in a window located in or overlapping with the first zone 322a.

The electronic device 302 (e.g., processor 340) may enable 508 a privacy mode 318a in the first zone 322a. For example, the processor 340 may instruct the first display controller 316a to enable 508 privacy mode 318a in the first zone 322a. First display controller 316a may adjust display parameters (e.g., emitted light, viewing angle, PDLC film opacity) to reduce the observability of content displayed in the first zone 322a.

The electronic device 302 (e.g., processor 340) may determine 510 that the second zone 322b of the display screen 320 does not include displayed data 312 with sensitive information 314. For example, the sensitive information 314 may not be placed in a window located in or overlapping with the second zone 322b.

The electronic device 302 (e.g., processor 340) may enable 512 a sharing mode 332b in the second zone 322b. In sharing mode 332b, the display parameters (e.g., emitted light, viewing angle, PDLC film opacity) of the second zone 422b may be set to normal operating conditions. For example, a second display controller 316b may adjust display parameters (e.g., emitted light, viewing angle, PDLC film opacity) to normal operating conditions in the second zone 322b.

The electronic device 302 (e.g., processor 340) may determine 514 that that the displayed data 312 with sensitive information 314 has moved from the first zone 322a to the second zone 322b. For example, the sensitive information 314 may be moved to a window located in or overlapping with the second zone 322b. The electronic device 302 may enable 516 privacy mode 318b in the second zone 322b. For example, the processor 340 may instruct the second display controller 316b to enable 516 privacy mode 318b in the second zone 322b. The second display controller 316b may adjust display parameters (e.g., emitted light, viewing angle, PDLC film opacity) to reduce the observability of content displayed in the second zone 322b.

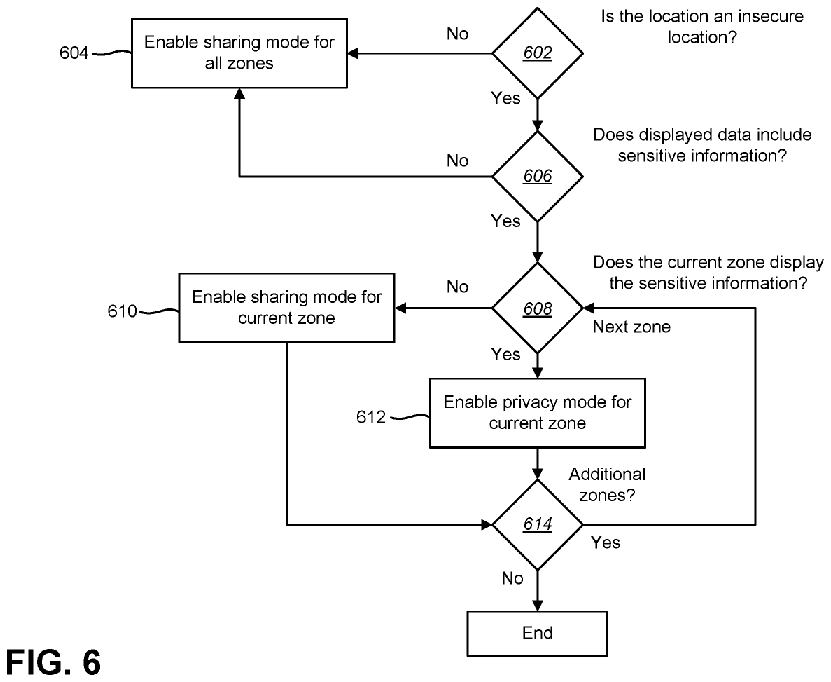

FIG. 6 is a flow diagram illustrating yet another method 600 for multi-zone display privacy based on location and content. The method 600 may be performed by, for example, an electronic device 102 and/or a processor 340. In some examples, the electronic device 102 may include or may communicate with a multiple-zone display screen 120.

The electronic device 102 (e.g., processor 340) may determine 602 whether the location 106 of the electronic device 102 is an insecure location 110. If the location 106 is not an insecure location 110, then the electronic device 102 may enable 604 sharing mode in all zones 122. For example, the—electronic device 102 may adjust display parameters (e.g., emitted light, viewing angle, PDLC film opacity) to normal operating conditions in all zones 122.

If the electronic device 102 determines 602 that the location 106 of the electronic device 102 is an insecure location 110, then the electronic device 102 (e.g., processor 340) may determine 606 whether the displayed data 112 includes sensitive information 114. If the displayed data 112 does not include sensitive information 114, then the electronic device 102 may enable 604 sharing mode in all zones 122.

If the electronic device 102 determines 606 that the displayed data 112 includes sensitive information 114, then the electronic device 102 (e.g., processor 340) may determine 608 which zones 122 display the sensitive information 114. For example, the electronic device 102 may check all of the zones 122 to determine which zones 122 include displayed data 112 with sensitive information 114. Starting with a given zone 122 (referred to as the current zone), the electronic device 102 (e.g., processor 340) may determine 608 whether the current zone 122 displays sensitive information 114. If the current zone 122 does not display sensitive information 114, then the electronic device 102 (e.g., processor 340) may enable 610 sharing mode for the current zone 122. However, if the current zone 122 does display sensitive information 114, then the electronic device 102 (e.g., processor 340) may enable 612 privacy mode 118 for the current zone 122.

After enabling privacy mode 118 or sharing mode for the current zone 122, the electronic device 102 (e.g., processor 340) may determine 614 whether there are additional zones 122 to evaluate. If there are additional zones 122, then the next zone 122 becomes the current zone 122 and the electronic device 102 determines 608 whether this zone 122 displays sensitive information 114 and enables privacy mode 118 or sharing mode accordingly. Once the electronic device 102 determines 614 that there are no additional zones 122 to evaluate, then the method 600 ends.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. An electronic device, comprising:
a location engine to determine a location of the electronic device;
a privacy engine to determine the location to be an insecure location and to determine that displayed data includes sensitive information; and
a display controller to enable a privacy mode in a zone of a multiple-zone display screen in response to a determination that the location is an insecure location and the displayed data includes sensitive information.

2. The electronic device of claim 1, wherein the location engine determines the location of the electronic device based on a GPS signal, an IP address, or an environmental factor.

3. The electronic device of claim 1, wherein the privacy engine determines that the location of the electronic device is an insecure location in response to a determination that the electronic device is outside of a pre-defined safe location.

4. The electronic device of claim 1, wherein the privacy engine determines that the location of the electronic device is an insecure location in response to a determination that the electronic device is in a public location.

5. The electronic device of claim 1, wherein the privacy engine determines that the displayed data includes sensitive information based on content of the displayed data that is marked as private.

6. The electronic device of claim 1, wherein the privacy engine determines that the displayed data includes sensitive information based on an indicator that the displayed data includes sensitive information.

7. An electronic device, comprising:
a location engine to determine a location of the electronic device;
a privacy engine to:
determine the location to be an insecure location,
determine that displayed data includes sensitive information, and
determine that a first zone of a multiple-zone display screen is to display the sensitive information; and
a first display controller to enable a privacy mode in the first zone of the display screen in response to a determination that the location is an insecure location and the displayed data includes sensitive information.

8. The electronic device of claim 1, further comprising a second display controller to enable a sharing mode in a second zone of the display screen in response to a determination that the second zone does not include displayed data with sensitive information.

9. The electronic device of claim 8, wherein the privacy mode is enabled in the first zone and sharing mode is enabled in the second zone.

10. The electronic device of claim 8, wherein the second display controller enables the privacy mode in the second zone of the display screen in response to a determination that the displayed data with sensitive information has moved from the first zone to the second zone.

11. A method, comprising:
determining that a location of an electronic device is an insecure location;
determining that displayed data includes sensitive information;
determining that a first zone of a multiple-zone display screen is to display the sensitive information; and
enabling a privacy mode in the first zone of the display screen in response to determining that the location is an insecure location and the displayed data includes sensitive information.

12. The method of claim 11, further comprising:
determining that a second zone of the display screen does not include displayed data with sensitive information; and
enabling a sharing mode in the second zone of the display screen in response to determining second the second zone does not include displayed data with sensitive information.

13. The method of claim 11, wherein enabling the privacy mode in the first zone comprises causing a polymer dispersed liquid crystal (PDLC) film in the first zone to become opaque.

14. The method of claim 11, wherein enabling the privacy mode in the first zone comprises increasing light emitted in the first zone.

15. The method of claim 11, wherein enabling the privacy mode in the first zone comprises adjusting a viewing angle of the first zone.
